(19) United States
(12) Patent Application Publication
(10) Pub. No.: US 2008/0021713 A1
(43) Pub. Date: Jan. 24, 2008

(54) ADDITIZING HEAVY FUEL OIL AT TERMINALS

(76) Inventors: Michael W. Meffert, Chesterfield, VA (US); Thomas G. Quinn, Hanover, VA (US)

Correspondence Address: MH2 TECHNOLOGY LAW GROUP (Cust. No. w/NewMarket), 1951 KIDWELL DRIVE, SUITE 550, TYSONS CORNER, VA, 22182, US

(21) Appl. No.: 11/458,220

(22) Filed: Jul. 18, 2006

(51) Int. Cl. G06Q 10/00; G06Q 30/00

(52) U.S. Cl. 705/1

(57) ABSTRACT

There is disclosed a method of providing at least one fuel additive to a heavy fuel oil, the method comprising: adding at least one fuel additive into a container comprising a heavy fuel oil, the addition occurring at a location removed from the end use site.

### FIELD OF THE DISCLOSURE

The present disclosure relates to a method for additizing heavy fuel oils upstream from the end use site and as close to the fuel's source as possible. This represents both a technical process and a business method.

### BACKGROUND OF THE DISCLOSURE

Heavy fuel oils, such as number 4 and number 6, fuel oil are used in electrical power generating units. Heavy fuel oils, such as bunker oil, are used in large marine engines. By “heavy fuel oil” herein is meant Grade No. 4 to Grade No. 6 fuel oil, such as Grade No. 4 (light), Grade No. 4, Grade No. 5 (light), Grade No. 5 (heavy), and Grade No. 6 (also referred to as Bunker C) as specified by ASTM D396-05. In ASTM D396-05, the fuel properties that dictate the grade of fuel oil are at least one of the following: flash point, water content, sediment content, viscosity, ash point, and pour point.

In all these cases, additization (i.e., the addition of various desired fuel additives to impart specific properties or performance characteristics to the fuel) is conventionally done either on-site or into the fuel line leading to the combustion chamber, or into the combustion chamber, or into the flue gas out of the combustion chamber. The problem with this additizing practice is that the additive(s) generally needs to be stored and dispensed on each site, requiring substantial investment in on-site trained manpower and multiple specialized additive-dispensing equipment. Since Additives injected directly into the boiler or furnace through a dedicated nozzle (or nozzles) often suffer from poor mixing and streamline flow (and therefore poor and/or non-uniform performance) resulting from the laminar flow present in many systems.

Also, many traditional heavy fuel oil additive products, including MgO and Mg(OH)₂ are aqueous and/or slurried products that are known to those skilled in the art to suffer from severe handling issues, including settling and line plugging. While these handling issues can be managed reasonably well with good engineering practices, unavoidable occurrences like pump failure and electrical power loss mean that these handling problems will inevitably be encountered.

Afton Chemical Corporation and other fuel additive suppliers have a long history of additizing fuels, including gasoline and diesel fuel other than heavy fuel oil, at refineries and terminals, upstream of the fuels' ultimate end-user. This is because of stringent EPA emissions regulations associated with on-road use of these fuels that necessitate wide and comprehensive use of additives. On the other hand, use of off-road fuels such as all grades of fuel oils in marine, industrial boilers/furnaces, and in utility power furnaces has not attracted much additive use primarily because of lax or nonexistent emissions regulation of these industries. Therefore a need to innovate more cost effective ways to additize these off-road fuels has been absent until recently with the ratcheting up of emissions regulations of power plants and other off road industries consuming fossil fuels and exhausting emissions into the environment. As these regulations become more stringent, it is anticipated that additives use will increase. Because of these reasons and the well known problems of stability and handling difficulties mentioned above, however, heavy fuel oil heretofore has not been additized in an off-site fashion similar to these other fuels.

### SUMMARY OF THE DISCLOSURE

In an aspect, there is disclosed a method of providing at least one fuel additive to a heavy fuel oil, said method comprising: adding at least one fuel additive into a container comprising a heavy fuel oil, said addition occurring at a location removed from the end use site.

In another aspect, there is disclosed a method of conducting the business of providing additives to heavy fuel oil, said method comprising: introducing at least one fuel additive to a heavy fuel oil when the heavy fuel oil is located at a position remote from the heavy fuel oil's end use site and said position is selected from the group consisting of a storage terminal, a distribution terminal, and a land or water vehicle transporting the heavy fuel oil.

In a further aspect, there is disclosed a method to improve heavy fuel oil delivery for the reduction or elimination of handling, compatibility and stability issues associated with use of at least one fuel additive, said method comprising: adding to a heavy fuel oil, at a location remote from end use site, at least one fuel additive to produce an additized heavy fuel oil; and moving the additized heavy fuel oil to its end use site.

There is also disclosed a method to improve heavy fuel oil delivery for the reduction or elimination of additive handling and/or storage equipment at an end use site, said method comprising: adding to a heavy fuel oil, at a location remote from end use site, at least one fuel additive to produce an additized heavy fuel oil; and moving the additized heavy fuel oil to its end use site.

Moreover, there is disclosed a method to improve heavy fuel oil delivery for the reduction or elimination of maintenance of additive handling and/or storage equipment, said method comprising: adding to a heavy fuel oil, at a location remote from end use site, at least one fuel additive to produce an additized heavy fuel oil; and moving the additized heavy fuel oil to its end use site.

In an aspect, there is disclosed a method to improve heavy fuel oil delivery for the reduction or elimination of the footprint required for additive handling and/or storage equipment, said method comprising: adding to a heavy fuel oil, at a location remote from end use site, at least one fuel additive to produce an additized heavy fuel oil; and moving the additized heavy fuel oil to its end use site.

In a further aspect, there is disclosed a method to improve heavy fuel oil delivery for the reduction or elimination of cost of additive handling and/or storage equipment, said method comprising: adding to a heavy fuel oil, at a location remote from end use site, at least one fuel additive to produce an additized heavy fuel oil; and moving the additized heavy fuel oil to its end use site.

There is also disclosed a method to improve heavy fuel oil delivery for the elimination of deliveries of fuel additive products to an end use site, said method comprising: adding to a heavy fuel oil, at a location remote from end use site, at least one fuel additive to produce an additized heavy fuel oil; and moving the additized heavy fuel oil to its end use site.

Moreover, there is disclosed a method to improve heavy fuel oil delivery for the reduction or elimination of traffic at an end use site associated with said deliveries of fuel additives, said method comprising: adding to a heavy fuel oil, at a location remote from end use site, at least one fuel additive to produce an additized heavy fuel oil; and moving the additized heavy fuel oil to its end use site.

Further, there is disclosed a method to improve heavy fuel oil delivery for the elimination or reduction of end use site resources required for said heavy fuel additives deliveries, said method comprising: adding to a heavy fuel oil, at a location remote from end use site, at least one fuel additive to produce an additized heavy fuel oil; and moving the additized heavy fuel oil to its end use site.

In a further aspect, there is disclosed a method to treat individual problematic heavy fuel oil batches with fuel additive products prior to delivery of said heavy fuel oil to an end use site, said method comprising: adding to a heavy fuel oil, at a location remote from the end use site, at least one fuel additive to produce an additized heavy fuel oil; and moving the additized heavy fuel oil to the end use site, whereby subsequent handling and stability problems are minimized or eliminated relative to that which would be encountered when such heavy fuel oil batches are mixed with heavy fuel oil(s) or fuel additives at the end use site.

Additional objects and advantages of the disclosure will be set forth in part in the description which follows, and/or can be learned by practice of the disclosure. The objects and advantages of the disclosure will be realized and attained by means of the elements and combinations particularly pointed out in the appended claims.

It is to be understood that both the foregoing general description and the following detailed description are exemplary and explanatory only and are not restrictive of the disclosure, as claimed.

### DESCRIPTION OF THE EMBODIMENTS

To obviate these and other problems associated with additizing heavy fuel oils, the present disclosure provides in an aspect a process for providing at least one fuel additive to a heavy fuel oil, the process comprising adding at least one fuel additive into a container comprising heavy fuel oil, the addition can occur at a location removed from the end use site of the heavy fuel oil.

The heavy fuel oil, fuel additive, and/or additized heavy fuel oil can be stored or transported in any container, including, but not limited to, a receptacle, such as a tank; a conduit, such as a pipeline; and a vehicle. The heavy fuel oil, fuel additive, and/or additized heavy fuel oil can be transported by any transportation means including, but not limited to a vehicle, such as a barge, rail car, truck or tanker; and a conduit, such as a pipeline, for example an oil feed line.

The at least one fuel additive can be added into the heavy fuel oil as far upstream from its end use site as possible, for example, additizing at storage and distribution terminals, and even in vehicles transporting or unloading these additized heavy fuels oils. By “storage terminal” herein is meant an oil storage facility downstream of the final production point, including the finished product storage tanks at a refinery, but upstream of the storage facilities located at the end use site. By “distribution terminal” herein is meant a facility where oil is collected from upstream producers or storage facilities and distributed to another downstream user or facility via any suitable transportation means. This facility would be located upstream of the end use site. In an aspect, a facility could be both a storage terminal and a distribution terminal.

By “end use site” herein is meant a facility wherein the additized heavy fuel oil is used for its intended purpose. The end use site can be, for example, a power station. In an aspect, the end use site is (a) the combustion unit for the combustion of the heavy fuel oil, or (b) a storage tank at a power station where the heavy fuel oil is to be combusted.

By “remote” or “removed from” herein is meant a location not on the property or premises of the fuel's end use site, where for example, a distance of at least several hundred yards and for example miles, and in an aspect, dozens, hundreds or thousands of miles can exist between the addition location and the fuel's end use site.

The at least one fuel additive can be any additive that can impart specific properties or performance characteristics to the fuel. Some of the properties include, but are not limited to, combustion improvement, slag modification, deposit control, corrosion control, to lower maintenance costs, improve unit availability, reduce emissions, and other benefits.

In an aspect, the at least one fuel additive can be a combustion improver used to reduce opacity (smoke and soot), improve flash properties, stabilize combustion and enable better boiler tuning. Such combustion improvers are often organometallic to ensure or improve solubility, and can include for example methyl cyclopentadiene manganese tricarbonyl (MMT®), cyclopentadiene manganese tricarbonyl (CMT) (neat or in a diluent), manganese carboxylate, iron carboxylate, ferrocene, calcium sulfonate, and cerium compounds. Another type of additive useful herein is magnesium-based chemistry used to increase slag melting temperatures, reduce SO₃ formation, reduce formation of corrosive vanadium compounds and neutralize sulfuric acid and its precursors in the flue gas. Non-limiting examples of these slag modification compounds include magnesium sulfonate and magnesium carboxylate.

In an aspect, the at least one fuel additive useful herein can be in a form that is oil soluble or if not, in a form that can be well dispersed in the heavy fuel oil either by emulsification or suspension using emulsifiers, detergents and dispersants that inhibit additive stratification over time due to, for example, gravity or temperature variation.

The at least one fuel additive can also be chosen from detergents, dispersants, antioxidants, and other fuel stabilizers necessary to prevent all storage and handling problems from the point of fuel oil additization all the way to the end use site.

Additizing heavy fuel oil pursuant to the present disclosure provides a number of valuable benefits to the end user, including but not limited to: (1) reduction or elimination of handling, compatibility and stability issues associated with use of non-oil soluble products; (2) reduction or elimination of additive handling and storage equipment at end use sites, including but not limited to storage tanks, day tanks, supply pumps, feed pumps, associated piping and tubing and additive feed and storage system control equipment (flowmeters, level control, etc.); (3) reduction or elimination of maintenance of said equipment in benefit #2 above; (4) reduction or elimination of footprint required for said equipment in benefit #2 above; (5) reduction or elimination of cost of said equipment in benefit #2 above; (6) elimination of deliveries of additive products to the end use site; (7) reduction or elimination of traffic at the end use site associated with said deliveries in benefit #6; (8) elimination or reduction of end use site resources required for said additives deliveries in benefit #6; and/or (9) opportunity to treat individual problematic heavy fuel oil batches with additional additive products (including but not limited to stabilizers, asphaltene dispersants, and detergents) prior to delivery of fuel oil to the end use site to minimize or eliminate subsequent handling and stability problems that might be encountered when such batches are mixed with other potentially incompatible fuel oil(s) already in storage.

Thus, the present disclosure provides methods or processes for achieving these multiple benefits by adding to a heavy fuel oil, at a location removed from its end use site, at least one fuel additive to produce an additized heavy fuel oil; and moving the additized heavy fuel oil to its end use site.

One example of such a method is a method to improve heavy fuel oil delivery comprising reduction or elimination of handling, compatibility and stability issues associated with the introduction of oil-soluble and non-oil soluble products and other fuel additives into a heavy fuel oil. The method can comprise adding to a heavy fuel oil, at a location removed from its end use site, at least one fuel additive to produce an additized heavy fuel oil; and moving the additized heavy fuel oil to its end use site.

According to the present disclosure, additive addition, such as by injection, directly into the heavy fuel oil prior to reaching the burner (either into a fuel feed line or a storage tank) has the automatic benefit of assurance that such additive(s) will remain in contact with the fuel, combustion products and/or combustion by-products (slag and ash) throughout the entire boiler system, including the furnace, convective pass sections, air pre-heater, backend emission control equipment and stack.

An embodiment presented herein provides a heavy fuel oil that is fortified for stability and longevity of the fuel during storage and transportation to its end use site.

Thus, in another embodiment herein is provided a method of conducting the business of providing at least one fuel additive(s) to heavy fuel oil, wherein the method comprises introducing at least one fuel additive to a heavy fuel oil when the heavy fuel oil is located at a position remote from the end use site, and the position is selected from the group consisting of a storage terminal, a distribution terminal, and a land or water vehicle transporting the heavy fuel oil.

### EXAMPLES

It is contemplated in an embodiment herein that one of ordinary skill in the art would add a fuel additive, such as MMT®, to a Grade No. 6 bunker oil in a storage tank at a storage terminal. The additized heavy fuel oil could then be transported by a barge to a distribution terminal.

At the distribution terminal, the additized heavy fuel oil could be separated into different storage tanks. In each separate storage tank a different additional fuel additive could be added, such as a dispersant in one tank and an antioxidant in a second tank. The further additized heavy fuel oil could then be transported to an end use site via a conduit, such as a pipeline. At the end use site, the additized heavy fuel could be transported to a combustion chamber via an oil feed line.

At numerous places throughout this specification, reference has been made to a number of U.S. patents, published foreign patent applications and published technical papers. All such cited documents are expressly incorporated in full into this disclosure as if fully set forth herein.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

It is noted that, as used in this specification and the appended claims, the singular forms “a,” “an,” and “the,” include plural referents unless expressly and unequivocally limited to one referent. Thus, for example, reference to “an antioxidant” includes two or more different antioxidants. As used herein, the term “include” and its grammatical variants are intended to be non-limiting, such that recitation of items in a list is not to the exclusion of other like items that can be substituted or added to the listed items.

This invention is susceptible to considerable variation in its practice. Therefore the foregoing description is not intended to limit, and should not be construed as limiting, the invention to the particular exemplifications presented hereinabove. Rather, what is intended to be covered is as set forth in the ensuing claims and the equivalents thereof permitted as a matter of law.

Applicant does not intend to dedicate any disclosed embodiments to the public, and to the extent any disclosed modifications or alterations may not literally fall within the scope of the claims, they are considered to be part of the invention under the doctrine of equivalents.

What is claimed is

1. A method of providing at least one fuel additive to a heavy fuel oil, said method comprising:
adding at least one fuel additive into a container comprising a heavy fuel oil,
said addition occurring at a location removed from the end use site.

2. The method of claim 1, wherein the at least one fuel additive is added into the heavy fuel oil at a storage terminal.

3. The method of claim 1, wherein the at least one fuel additive is added into the heavy fuel oil at a distribution terminal.

4. The method of claim 1, wherein the at least one fuel additive is added into the heavy fuel oil in a vehicle.

5. The method of claim 1, wherein the at least one fuel additive is selected from the group consisting of methyl cyclopentadiene manganese tricarbonyl, neat cyclopentadiene manganese tricarbonyl, cyclopentadiene manganese tricarbonyl in a diluent, manganese carboxylate, iron carboxylate, ferrocene, calcium sulfonate, cerium compounds, magnesium sulfonate, and magnesium carboxylate.

6. The method of claim 1, wherein the at least one fuel additive is chosen from detergents, dispersants, combustion improvers, slag modification compounds, and antioxidants.

7. A method of conducting the business of providing additives to heavy fuel oil, said method comprising:
introducing at least one fuel additive to a heavy fuel oil when the heavy fuel oil is located at a position remote from the heavy fuel oil's end use site and said position is selected from the group consisting of a storage terminal, a distribution terminal, and a land or water vehicle transporting the heavy fuel oil.

8. A method to improve heavy fuel oil delivery for the reduction or elimination of handling, compatibility and stability issues associated with use of at least one fuel additive, said method comprising:
adding to a heavy fuel oil, at a location remote from end use site, at least one fuel additive to produce an additized heavy fuel oil; and
moving the additized heavy fuel oil to its end use site.

9. A method to improve heavy fuel oil delivery for the reduction or elimination of additive handling and/or storage equipment at an end use site, said method comprising:
adding to a heavy fuel oil, at a location remote from end use site, at least one fuel additive to produce an additized heavy fuel oil; and
moving the additized heavy fuel oil to its end use site.

10. The method of claim 9, wherein the additive handling and/or storage equipment is chosen from storage tanks, day tanks, supply pumps, feed pumps, associated piping, associated tubing, flowmeters, and level controls.

11. A method to improve heavy fuel oil delivery for the reduction or elimination of maintenance of additive handling and/or storage equipment, said method comprising:
adding to a heavy fuel oil, at a location remote from end use site, at least one fuel additive to produce an additized heavy fuel oil; and
moving the additized heavy fuel oil to its end use site.

12. A method to improve heavy fuel oil delivery for the reduction or elimination of the footprint required for additive handling and/or storage equipment, said method comprising:
adding to a heavy fuel oil, at a location remote from end use site, at least one fuel additive to produce an additized heavy fuel oil; and
moving the additized heavy fuel oil to its end use site.

13. A method to improve heavy fuel oil delivery for the reduction or elimination of cost of additive handling and/or storage equipment, said method comprising:
adding to a heavy fuel oil, at a location remote from end use site, at least one fuel additive to produce an additized heavy fuel oil; and
moving the additized heavy fuel oil to its end use site.

14. A method to improve heavy fuel oil delivery for the elimination of deliveries of fuel additive products to an end use site, said method comprising:
adding to a heavy fuel oil, at a location remote from end use site, at least one fuel additive to produce an additized heavy fuel oil; and
moving the additized heavy fuel oil to its end use site.

15. A method to improve heavy fuel oil delivery for the reduction or elimination of traffic at an end use site associated with said deliveries of fuel additives, said method comprising:
adding to a heavy fuel oil, at a location remote from end use site, at least one fuel additive to produce an additized heavy fuel oil; and
moving the additized heavy fuel oil to its end use site.

16. A method to improve heavy fuel oil delivery for the elimination or reduction of end use site resources required for said heavy fuel additives deliveries, said method comprising:
adding to a heavy fuel oil, at a location remote from end use site, at least one fuel additive to produce an additized heavy fuel oil; and
moving the additized heavy fuel oil to its end use site.

17. A method to treat individual problematic heavy fuel oil batches with fuel additive products prior to delivery of said heavy fuel oil to an end use site, said method comprising:
adding to a heavy fuel oil, at a location remote from the end use site, at least one fuel additive to produce an additized heavy fuel oil; and
moving the additized heavy fuel oil to the end use site, whereby subsequent handling and stability problems are minimized or eliminated relative to that which would be encountered when such heavy fuel oil batches are mixed with heavy fuel oil(s) or fuel additives at the end use site.
